(19) United States
(12) Patent Application Publication
(10) Pub. No.: US 2010/0257113 A1
(43) Pub. Date: Oct. 7, 2010

(54) METRIC-BASED EVENTS FOR SOCIAL NETWORKS

(75) Inventor: Wade Clark Dorrell, Boise, ID (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/418,625

(22) Filed: Apr. 6, 2009

(51) Int. Cl. G06Q 99/00

(52) U.S. Cl. 705/319

(57) ABSTRACT

Events occurring with respect to metrics are defined. When an event occurs with respect to a metric, a notification of the event is generated in a social network, such as an enterprise social network. The notification might include the name of a user associated with the event and the name of the event. Comments may be left regarding the notification of the event. The comments can be retrieved and analyzed.

### BACKGROUND

Organizations often define and evaluate metrics to monitor the performance of the organization and its employees. Metrics are a quantifiable measure of a characteristic of the performance of the organization or its employees. For instance, one aspect of the performance of a nurse employed by a hospital might be measured by evaluating the number of patients that the nurse is responsible for at a particular time against a goal or target value. In another scenario, an aspect of the performance of a salesperson might be evaluated by comparing the volume of sales made by the salesperson at a particular point in time against a sales target. Metrics may be defined and monitored in this manner for individuals, groups, departments, and even entire organizations.

Although metrics are commonly utilized to measure the performance of individuals and organizations, the full potential of metrics is not realized in many scenarios. In one example scenario, for instance, a team of nurses might maintain a spreadsheet to track the number of patients each nurse is responsible for. If the number of patients a nurse is responsible for is greater than a certain value, then the nurse is overloaded. If the number of patients the nurse is responsible for is less than another value, then the nurse is free to help other overloaded nurses or to be sent home. In this way, each of the nurses can utilize the spreadsheet to monitor the current status of the other nurses on the team. However, if the nurses do not see one another in person and negotiate the allocation of patients between themselves, then the value of the metrics defined and monitored by way of the spreadsheet is reduced. This is a common shortcoming of the metrics defined and monitored within many organizations.

It is with respect to these and other considerations that the disclosure presented herein has been made.

### SUMMARY

Technologies are described herein for metric-based events for social networks. Through an implementation of the embodiments presented herein, a notification is generated in a social network when an event occurs with respect to a metric. Through the notification, users in the social network are informed of the occurrence of the event and can take appropriate action. For instance, in the example given above, a notification might be provided to each of the nurses in a social network when one of the nurses is overloaded with patients. The nurses can then take coordinated action in order to assist the overloaded nurse.

According to some embodiments presented herein, a mechanism is provided through which events occurring with respect to metrics can be defined. For instance, a user might define an event by specifying a threshold value for a metric. When an actual value for the metric crosses (e.g. becomes less than or greater than) the threshold value, an event is considered to have occurred with respect to the metric. The user might also provide a friendly name to describe the event.

Once an event has been defined, an actual value for the metric can be retrieved from a data source. The actual value can then be compared to the defined threshold value to determine if the event has occurred. If an event has occurred, a notification of the event is generated in a social network, such as an enterprise social network. For instance, the name of a user associated with the event and the name of the event might be displayed in an event or news feed of the social network. In this way, the notification of the event can be “pushed” into a social network. Alternatively, the notification of the event can be made available for retrieval, such as through the use of a Really Simple Syndication (“RSS”) or ATOM feed reader.

According to other aspects, users may be permitted to leave comments regarding the event in the event or news feed of the social network. In one implementation, the comments relating to an event are retrieved and stored. The comments can then be analyzed to determine, for instance, what events are occurring, the importance of the data underlying the events, and the users that are interested in each event. The results of this analysis can then be utilized for various purposes. For instance, the results of this analysis might be utilized to optimize the data sources utilized for metrics.

It should be appreciated that the above-described subject matter may also be implemented as a computer-controlled apparatus, a computer process, a computing system, as an article of manufacture such as a computer-storage medium, or in another manner. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1 and 2 are computer system architecture diagrams showing aspects of several software components provided in the embodiments presented herein;

FIG. 3 is a flow diagram showing a routine that illustrates aspects of some embodiments presented herein for providing metric-based events in a social network; and

FIG. 4 is a computer architecture diagram showing an illustrative computer hardware and software architecture for a computing system capable of implementing the embodiments presented herein.

### DETAILED DESCRIPTION

The following detailed description is directed to technologies for metric-based events for social networks. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, concepts and technologies for metric-based events in social networks will be described.

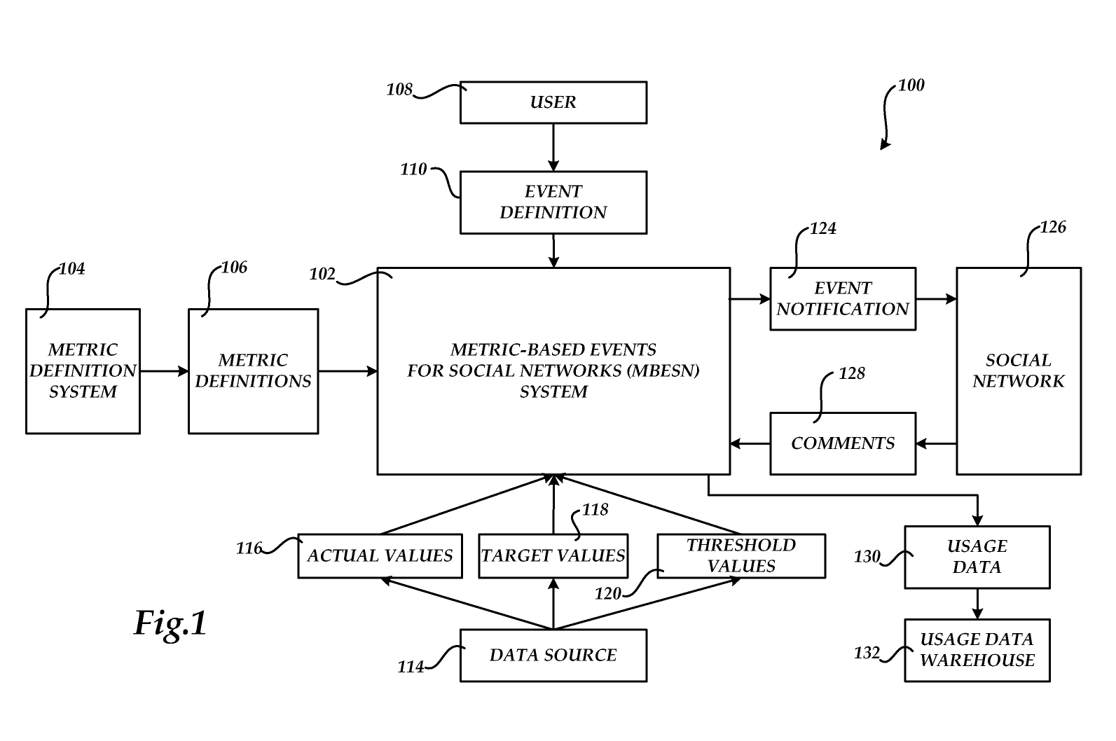

Turning now to FIG. 1, details will be provided regarding several software components provided by the embodiments presented herein. In particular, FIG. 1 shows a system 100 provided in one embodiment herein for generating metric-based events in a social network. The system 100 includes a metric-based events for social networks (“MBESN”) system 102. As discussed in detail below, the MBESN system 102 comprises one or more computing systems and software components that are collectively configured to generate events within a social network when defined events occur with respect to a metric. As discussed above, metrics are a quantifiable measurement of a characteristic of the performance of an organization or an employee. Metrics may be defined and utilized in the manner herein for individuals, groups, departments, and entire organizations. It should be appreciated that the MBESN system 102 shown in FIG. 1 and described herein may comprise many computing systems and software components and utilize various networks, all of which may not be illustrated or described herein. It should also be appreciated that the system 100 illustrated in FIG. 1 has been simplified for ease of discussion and that an actual implementation of the system 100 might also include many more computing systems, software components, and networks not illustrated in FIG. 1 or described herein.

According to some implementations, the MBESN system 102 operates in conjunction with a metric definition system 104. The metric definition system 104 allows a user to define the data to be utilized by a particular metric. This definition is reflected in a metric definition 106. For instance, in one implementation wherein data for a metric is retrieved from a database, the metric definition 106 may comprise a database query for retrieving the data necessary to evaluate the metric. The metric definitions 106 are utilized by the MBESN system 102 in the manner described below.

In some implementations, the metric definitions 106 provide instructions regarding the manner in which data for evaluating a metric should be retrieved from a data source 114. It should be appreciated that the data source 114 may comprise any type of electronic source from which data may be retrieved including, but not limited to, a database, a data warehouse, a system external to the MBESN such as an accounting system, a spreadsheet, a text document, or another type of data source.

In one implementation, the metric definitions 106 allow the MBESN system 102 to retrieve the values 116, 118, and 120 from the data source 114. The values 118 are target values for the metric. For instance, the target values 118 may comprise a sales target for a salesperson. The values 116 are the actual values for the metric. For instance, in the example given above with respect to a salesperson, the actual values 116 may represent the actual sales made by the salesperson for a given period. The values 120 are threshold values indicating when an event should be generated with respect to a metric. For instance, the threshold values 120 may be set as 50%, 100%, and 150% of the target value 118 for a salesperson. In this way, an event may be generated as the salesperson's actual values 116 cross each of the threshold values 120. It should be appreciated that, as utilized herein, the term “crossing” refers to the actual values 116 becoming greater or less than the threshold values 120 for a particular event defined with respect to a metric. It should be appreciated that the target values 118 and threshold values 120 may be stored in a data source 114 separate from the data source utilized to store the actual values 116.

According to some implementations, a user 108 defines the target values 118 and the threshold values 120. The user 108 may be the actual user that is being evaluated by a metric or may be a manager or supervisor of the user being evaluated. In this regard, the user 108 provides an event definition 110 that defines the events that should trigger notifications within a social network. According to some embodiments, the event definition 110 specifies the portion of the data source applicable to the user 108 and the particular metric being defined. For instance, if the data source 114 comprises a spreadsheet, the event definition 110 may identify the particular portion of the spreadsheet that identifies the actual values 116 for the user 108. If the data source 114 comprises a database table, the event definition 110 may define the particular rows and columns of the database table that identify the actual values 116 for the user 108. In an embodiment wherein the data source 114 is also utilized to store the target values 118 and the threshold values 120, the event definition 110 may also specify the location of these values within the data source 114.

According to some embodiments, the event definition 110 also identifies the threshold values 120 that should be utilized to determine whether an event has occurred with respect to a particular metric. For each threshold value 120 specified by the user 108, an event name may be provided that identifies the event that has occurred when the actual value 116 crosses the threshold value 102. For instance, in the example given above with regard to a team of nurses, the event definition 110 may be configured by a user 108 to identify the particular portion of the data source 114 that corresponds to each nurse. The user 108 might also identify the portion of the data source 114 that identifies the number of patients currently being handled by each nurse (the actual values 116) and several threshold values 120. For instance, the user 108 may specify a threshold value indicating that a nurse is overloaded and a threshold value indicating that a nurse is underloaded. The user 108 may also input the specific conditions for each threshold and a name to assign to those conditions that the team can understand. For instance, the user 108 may indicate that an event named “help wanted” is to occur when the current number of patients handled by any nurse is greater than the specified maximum threshold value 120. Similarly, the user 108 may define that an event named “free” is to be generated when the actual number of patients handled by a nurse is less than the minimum threshold value 120. It should be appreciated that any number of threshold values 120 may be identified with respect to a metric in this fashion.

According to implementations, the MBESN system 102 is configured to monitor the data source 114 for changes in the actual values 116 for each event definition 110. When a state change occurs as a result of a threshold value 120 crossing an actual value 116, the MBESN system 102 is configured to provide an event notification 124 to a social network 126. In the example given above, all of the nurses on the nursing team may be members of the social network 126 and receive the event notification 124. As known in the art, a social network 126 comprises a network of individuals based upon personal relationships. The social network 126 may provide functionality for viewing updates provided by other members of a user's social network and for commenting on the updates. Examples of social networks include, but are not limited to, social networks provided by FACEBOOK, INC., TWITTER, and others.

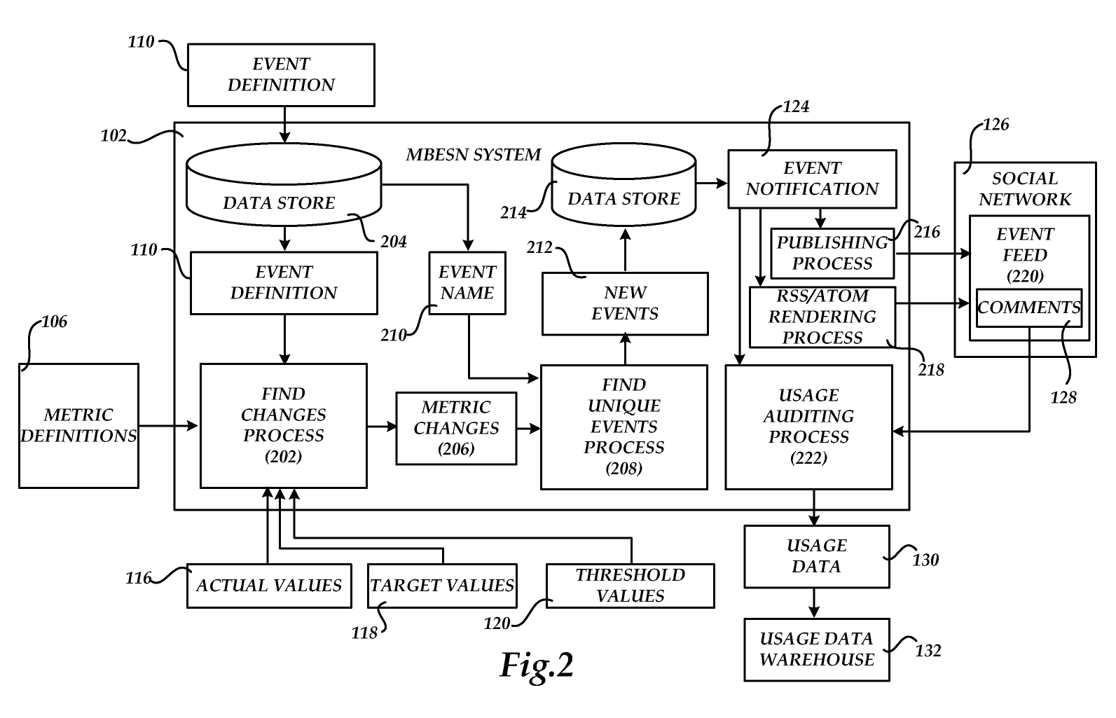

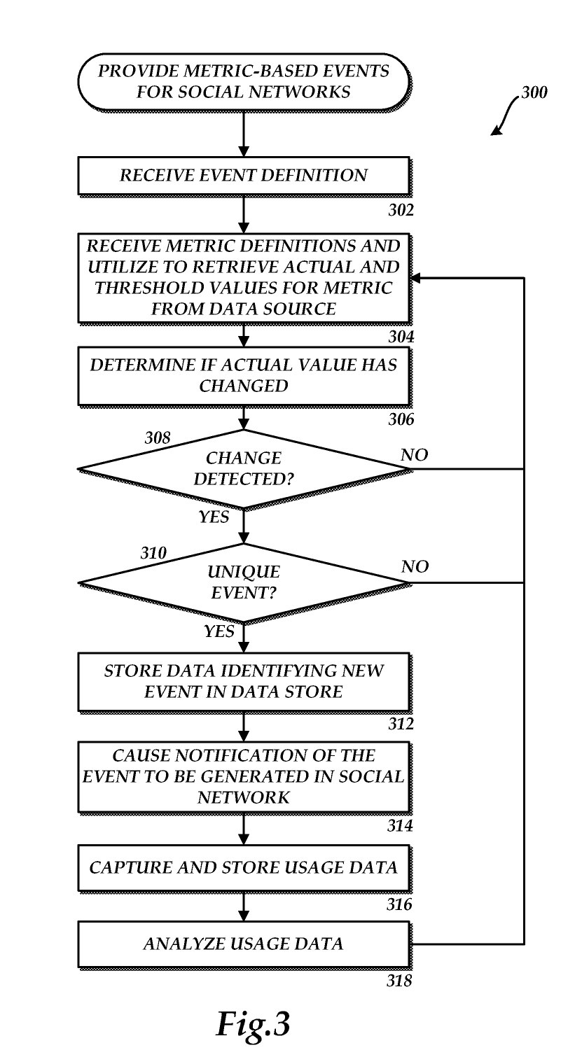

As discussed briefly above, the social network 126 may provide the ability for users to collaborate regarding event notifications 124 published to the social network 126. For instance, users may be permitted to post comments 128 on the social network 126 regarding an event notification 124. In one implementation, the MBESN system 102 is configured to retrieve usage data regarding the event notification 124 from the social network 126. In particular, in one implementation, the MBESN system 102 is configured to retrieve comments 128 from the social network 126 regarding the event notification 124. An analysis of the comments 128 may be made by the MBESN system 102 to generate usage data 130. The usage data 130 may be stored in a usage data warehouse 132 and utilized to improve the operation of the MBESN system 102. For instance, the usage data 130 may be utilized to determine, for instance, what events are occurring, the importance of the data underlying events, and the users that are interested in each event. The result of this analysis can then be utilized for various purposes including, but not limited to, optimizing the data source 114 utilized for generating the actual values 116. It should be appreciated that the usage data 130 may also be utilized for other purposes. Additional details regarding the configuration and operation of the MBESN system 102 in one particular embodiment presented herein will be described below with reference to FIGS. 2-3.

Referring now to FIG. 2, additional details will be provided regarding the configuration and operation of the MBESN system 102 in one implementation presented herein. As discussed briefly above with respect to FIG. 2, a metric definition system 104 may be utilized to provide metric definitions 106. As also discussed above, the metric definitions 106 can be utilized to retrieve the values 116, 118, and 120 from a data source 114. In one implementation of the MBESN system 102, a find changes process 202 utilizes the metric definitions 106. In particular, the find changes process 202 is configured to determine whether an event has occurred with respect to a metric by comparing the actual values 116 to the threshold values 120. In order to perform this functionality, the find changes process 202 also retrieves the event definition 110 that has been stored within a data store 204 within the MBESN system 102.

If the find changes process 202 identifies changes 206 to the actual values 116, the find changes process 202 supplies the changes 206 to a find unique events process 208. For instance, if the find changes process 202 determines that the actual values 116 have changed with respect to a metric defined by an event definition 110, the find changes process 202 provides the changes 206 to the find unique events process 208.

The find unique events process 208 is configured to determine whether the changes 206 identified by the process 202 identify a new event. In this way, the find unique events process 208 prevents a notification from being provided more than once for the same event. If the find unique events process 208 determines that a unique event has occurred with respect to a metric, the process 208 generates a new event 212 and stores the new event 212 in the data store 214. The new event may include the event name 210 associated with the particular threshold value 120 that caused the new event 212 to be generated. For instance, in the example given above with respect to a nursing team, a new event 212 may be generated indicating that “Betty is overloaded” or “Betty is free” for a nurse named Betty. The new event 212 may also be followed by the actual value 116. In this example, the new event might indicate the number of patients currently assigned to the nurse.

When a new event 212 is identified by the find unique events process 208, an event notification 124 is also generated. The event notification 124 may include the name of the event, the name of the user 108 associated with the event, and the actual value 116 associated with the event. The event notification 124 may be provided to a publishing process 216 for pushing the event notification 124 into the social network 126. In this regard, the social network 126 may expose an application programming interface (“API”) for allowing the publishing process 216 to provide the event notification 124. Alternatively, the event notification may be provided through a “pull” mechanism. For instance, in one implementation, a rendering process 218 is provided that makes the event notification 124 available to the social network 126 for retrieval. According to implementations, an RSS or ATOM formatted extensible markup language (“XML”) feed may be provided by the rendering process 218. It should be appreciated that other types of push or pull mechanisms may be utilized by the publishing process 216 and the rendering process 218, respectively.

According to one implementation, the event notification 124 is provided in an event feed 220 provided by the social network 126. An event feed 220 comprises a time-organized list of events occurring with respect to a user 108 and is provided to all of the other users within the social network 126. In the example given above with respect to a nursing team, the event feed 220 may include event notifications 124 provided by each of the nurses on the team and may be delivered to each of the nurses on the team. It should be appreciated that the event feed 220 may also be referred to as a “news” feed. It should also be appreciated that the social network 126 comprises an enterprise social network 126 in one implementation. An enterprise social network 126 is a social network utilized within a particular enterprise. In this type of implementation, the social network 126 is typically unavailable to the public at large.

According to implementations, the social network 126 is configured to provide a mechanism by which its members may collaborate on the events identified in the event feed 220. For instance, members of the social network 126 can provide comments 128 regarding each of the event notifications 124. In the example given herein with respect to a team of nurses, one of the nurses on the team may leave a comment 128 indicating that they are available to help an overloaded nurse in response to viewing an event notification 124 indicating that the other nurse is overloaded. In this manner, the members of the social network 126 can not only receive the event notifications 124 but can also collaborate regarding the event notifications and collectively determine a course of action for addressing a particular event.

As also illustrated in FIG. 2, a usage auditing process 222 may be executed by the MBESN system 102. The usage auditing process 222 also receives the event notifications 124. Additionally, the usage auditing process 222 retrieves comments 128 and other types of usage data 120 from the social network 126 and collectively stores the usage data 130 in the usage data warehouse 132. As discussed above, this data may be utilized to analyze the event that occurred, the importance of the data underlying events and the events themselves, and the users 108 that are interested in each event. The result of this analysis can then be utilized, for instance, to optimize the data source 114 utilized to generate the metrics.

Referring now to FIG. 3, additional details will be provided regarding the embodiments presented herein for providing metric-based events in social networks. In particular, FIG. 3 is a flow diagram showing aspects of one embodiment provided herein for generating metric-based events in a social network.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 300 begins at operation 302, where the MBESN system 102 receives the event definition 110 and stores the event definition in the data store 204. The routine 300 then proceeds to operation 304, where the MBESN system 102 receives the metric definitions 106. The find changes process 202 then utilizes the metric definitions 106 to retrieve the actual values 116 and the threshold values 120 for the metric from the data source 114. Based on the values retrieved from the data source 114, the find changes process 202 determines whether the actual values 116 have changed at operation 306. If no change has been detected, the routine proceeds from operation 308 to operation 304, where another query of the data source 114 is made by the find changes process 202 at a subsequent time. If a change to the actual values 116 is detected by the find changes process 202, the routine 300 proceeds from operation 308 to operation 310.

At operation 310, the find unique events process 208 determines whether the changes 206 identified by the find changes process 202 identify a new event with respect to the defined metric. If not, the routine 300 proceeds from operation 310 back to operation 304 where another query of the data source 114 is made at a subsequent time. If the find unique events process 208 identifies a unique event at operation 310, the routine 300 proceeds to operation 312 where data identifying the new event 212 is stored in the data store 214. The routine 300 then proceeds to operation 314, where the MBESN system 102 causes a notification 124 of the new event to be generated in the social network 126. As discussed above, the social network 126 comprises an enterprise social network in one implementation. Moreover, as also described above, the event notification 124 may be provided in an event feed 220 of the social network 126 by the publishing process 216 or the rendering process 218.

From operation 314, the routine 300 proceeds to operation 316 where the usage auditing process 222 captures and stores the usage data 130 from the social network 126. As discussed above, the usage data 130 may include comments 128 made by users 108 with respect to an event notification 124 published in the event feed 220. The usage auditing process 222 stores the data 130 in the usage data warehouse 132.

Once the usage data 130 has been stored in the data warehouse 132, the auditing process 222 may periodically analyze the usage data 130 at operation 318. As discussed above, the analysis of the usage data 130 may be utilized for various purposes including optimization of the data source 114. From operation 318, the routine 300 returns to operation 304, where the above-described process is repeated.

It should be appreciated that the process illustrated in FIG. 3 is repeated by the MBESN system 102 for each of the events defined by an event definition 110 and stored in the data store 204. It should also be appreciated that the MBESN system 102 can perform many such evaluations in parallel thereby providing event notifications 124 concurrently for many different events. It should also be appreciated that the metric evaluated by the MBESN system 102 may include any type of metric including, but not limited to, key performance indicators (“KPIs”). It should be further appreciated that the examples given herein are merely illustrative and should not be considered as limiting the scope of the disclosure presented herein.

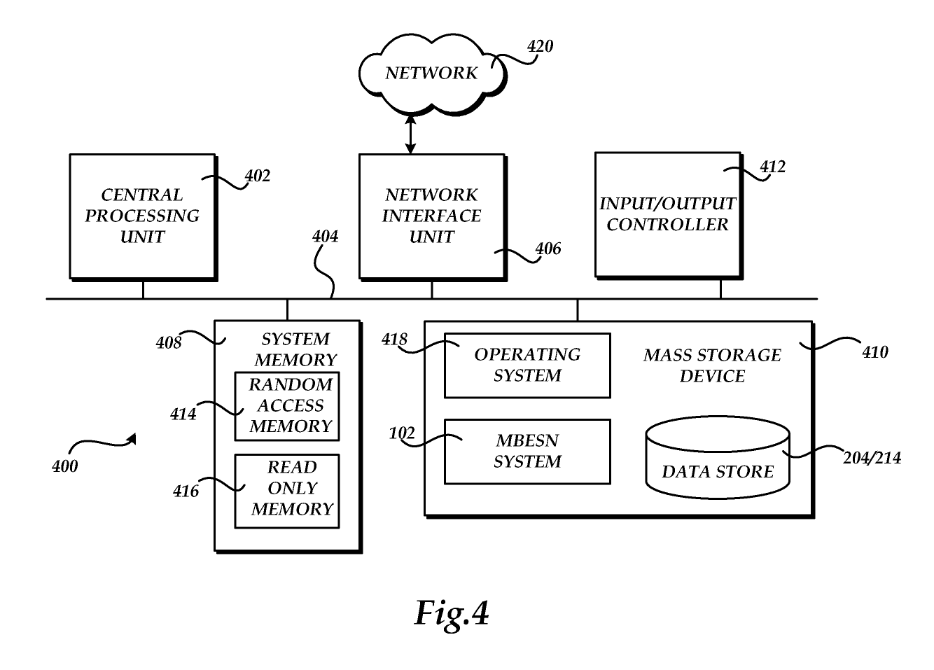

FIG. 4 shows an illustrative computer architecture for a computer 400 capable of executing the software components described herein for providing metric-based events in a social network. The computer architecture shown in FIG. 4 illustrates a conventional desktop, laptop, or server computer and may be utilized to execute any aspects of the software components presented herein.

The computer architecture shown in FIG. 4 includes a central processing unit 402 (“CPU”), a system memory 408, including a random access memory 414 (“RAM”) and a read-only memory (“ROM”) 416, and a system bus 404 that couples the memory to the CPU 402. A basic input/output system containing the basic routines that help to transfer information between elements within the computer 400, such as during startup, is stored in the ROM 416. The computer 400 further includes a mass storage device 410 for storing an operating system 418, application programs, and other program modules, which are described in greater detail herein.

The mass storage device 410 is connected to the CPU 402 through a mass storage controller (not shown) connected to the bus 404. The mass storage device 410 and its associated computer readable storage media provide non-volatile storage for the computer 400. Although the description of computer storage media contained herein refers to a mass storage device, such as a hard disk or CD-ROM drive, it should be appreciated by those skilled in the art that computer storage media can be any available computer storage media that can be accessed by the computer 400.

By way of example, and not limitation, computer storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network such as the network 420. The computer 400 may connect to the network 420 through a network interface unit 406 connected to the bus 404. It should be appreciated that the network interface unit 406 may also be utilized to connect to other types of networks and remote computer systems. The computer 400 may also include an input/output controller 412 for receiving and processing input from a number of other devices, including a keyboard, mouse, or electronic stylus (not shown in FIG. 4). Similarly, an input/output controller may provide output to a display screen, a printer, or other type of output device (also not shown in FIG. 4).

As mentioned briefly above, a number of program modules and data files may be stored in the mass storage device 410 and RAM 414 of the computer 400, including an operating system 418 suitable for controlling the operation of a networked desktop, laptop, or server computer. The mass storage device 410 and RAM 414 may also store one or more program modules. In particular, the mass storage device 410 and the RAM 414 may store program modules configured for execution by the CPU 402 for implementing some or all of the functionality of the MBESN system 102 and the data stores 204 and 214, each of which was described in detail above with respect to FIGS. 1-3. The mass storage device 410 and the RAM 414 may also store other types of program modules and data.

It should be appreciated that the software components described herein may, when loaded into the CPU 402 and executed, transform the CPU 402 and the overall computer 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein might also transform the physical structure of the computer storage media presented herein. The specific transformation of physical structure may depend on various factors, in different implementations of this description. Examples of such factors may include, but are not limited to: the technology used to implement the computer storage media, whether the computer storage media is characterized as primary or secondary storage, and the like. For example, if the computer storage media is implemented as semiconductor-based memory, the software disclosed herein may be encoded on the computer storage media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 400 in order to store and execute the software components presented herein. It also should be appreciated that the computer 400 may comprise other types of computing devices, including hand-held computers, embedded computer systems, personal digital assistants, and other types of computing devices known to those skilled in the art. It is also contemplated that the computer 400 may not include all of the components shown in FIG. 4, may include other components that are not explicitly shown in FIG. 4, or may utilize an architecture completely different than that shown in FIG. 4.

Based on the foregoing, it should also be appreciated that technologies for providing metric-based events in social networks have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer storage medium having computer-executable instructions stored thereupon which, when executed by a computer, cause the computer to:
receive an actual value for a metric;
receive a threshold value for the metric;
determine whether an event has occurred with respect to the metric by comparing the actual value to the threshold value; and to
cause a notification of the event to be generated in a social network in response to determining that the event has occurred.

2. The computer storage medium of claim 1, having further computer-executable instructions stored thereupon which, when executed by the computer, cause the computer to receive a name for the threshold value, and wherein causing a notification of the event to be generated in the social network comprises causing the name to be displayed in an event feed of the social network.

3. The computer storage medium of claim 1, having further computer-executable instructions stored thereupon which, when executed by the computer, cause the computer to:
retrieve one or more comments relating to the notification of the event from the event feed; and to
determine the importance of the event by analyzing the retrieved comments.

4. The computer storage medium of claim 3, wherein the social network comprises an enterprise social network.

5. The computer storage medium of claim 4, wherein causing a notification of the event to be generated in the social network comprises pushing a notification of the event into the social network.

6. The computer storage medium of claim 4, wherein causing a notification of the event to be generated in the social network comprises making the notification of the event available for retrieval.

7. The computer storage medium of claim 4, wherein the metric comprises a key performance indicator (KPI).

8. The computer storage medium of claim 7, wherein the notification of the event comprises the name and a name of a user associated with the event.

9. A computer-implemented method for providing a notification of the occurrence of a metric-based event in a social network, the computer-implemented method comprising performing computer-implemented operations for:
receiving a threshold value for the metric and a name associated with the threshold value;
retrieving an actual value for the metric;
determining whether an event occurred with respect to the metric by comparing the actual value to the threshold value; and
causing a notification of the occurrence of the event to be generated in a social network in response to determining that the event occurred.

10. The computer-implemented method of claim 9, wherein the notification comprises the name associated with the threshold value.

11. The computer-implemented method of claim 10, wherein the notification further comprises the name of a user associated with the actual value.

12. The computer-implemented method of claim 11, wherein causing a notification of the occurrence of the event to be generated in a social network comprises causing the notification of the event to be generated in an event feed of the social network.

13. The computer-implemented method of claim 12, wherein causing a notification of the occurrence of the event to be generated in a social network comprises pushing the notification of the event into the social network.

14. The computer-implemented method of claim 12, wherein causing a notification of the occurrence of the event to be generated in a social network comprises making the notification of the event available for retrieval.

15. The computer-implemented method of claim 12, wherein the social network comprises an enterprise social network.

16. The computer-implemented method of claim 12, further comprising:
retrieving one or more comments relating to the notification of the event from the event feed; and
determining the importance of the event by analyzing the retrieved comments.

17. A computer storage medium having computer-executable instructions stored thereupon which, when executed by a computer, cause the computer to:
determine based upon an actual value for a metric and a threshold value for the metric whether an event has occurred with respect to the metric;
in response to determining that an event has occurred with respect to the metric, to cause a notification of the event to be generated in an event feed of an enterprise social network;
retrieve one or more comments regarding the notification of the event from the event feed of the enterprise social network; and to
determine the importance of the event based upon the comments.

18. The computer-storage medium of claim 17, wherein causing a notification of the occurrence of the event to be generated in a social network comprises pushing the notification of the event into the social network.

19. The computer-storage medium of claim 17, wherein causing a notification of the occurrence of the event to be generated in a social network comprises making the notification of the event available for retrieval.

20. The computer-storage medium of claim 19, wherein the notification comprises a name associated with the threshold value and the name of a user associated with the actual value.
